(19) United States
(12) Patent Application Publication
(10) Pub. No.: US 2021/0265900 A1
(43) Pub. Date: Aug. 26, 2021

(54) ROTARY ELECTRIC MACHINE AND MANUFACTURING METHOD OF ROTARY ELECTRIC MACHINE

(71) Applicant: KYB Corporation, Tokyo (JP)

(72) Inventors: Sayaka UENO, Tokyo (JP); Takayuki KAWAGUCHI, Tokyo (JP); Shun MATSUDA, Tokyo (JP); Tarou MATSUMAE, Tokyo (JP)

(73) Assignee: KYB Corporation, Tokyo (JP)

(21) Appl. No.: 17/182,183

(22) Filed: Feb. 22, 2021

(30) Foreign Application Priority Data
Feb. 26, 2020 (JP) 2020-030992

(51) Int. Cl. H02K 15/14; H02K 5/02

(52) U.S. Cl. CPC H02K 15/14; H02K 5/02

(57) ABSTRACT

An object of the present invention is to maintain the tightening load between a casing and a stator appropriately even when used in a high temperature environment.

A rotary electric machine includes a rotor, a stator made of an iron-based member and provided on an outer periphery of the rotor, and a casing that is made of an aluminum alloy member, houses the rotor and the stator, and fixes the stator by bringing an inner peripheral surface into contact with an outer peripheral surface of the stator. The casing is permanently grown before the stator is fixed in the casing.

### TECHNICAL FIELD

The present invention relates to a rotary electric machine and a manufacturing method of a rotary electric machine.

### BACKGROUND ART

For example, as a rotary electric machine (motor) for a power steering system, a rotary electric machine described in Patent Literature 1 is known. As shown in Patent Literature 1, the rotary electric machine includes a rotor, a stator, and a casing that houses the rotor and the stator. The stator is press-fitted into the casing so that an outer peripheral surface is in contact with and fixed to an inner peripheral surface of the casing. Additionally, Patent Literature 1 describes that the casing is made of an aluminum alloy.

### CITATION LIST

### Patent Literature

### Patent Literature 1: JP 2017-208872 A

### SUMMARY OF INVENTION

### Technical Problem

Here, the rotary electric machine is sometimes used in a high temperature environment. When used in a high temperature environment, an aluminum alloy casing may undergo irreversible expansion called permanent growth. In this case, the inner diameter of the casing becomes large during the use of the rotary electric machine, the tightening margin between the casing and the stator becomes small, and there is a possibility that the tightening load between the casing and the stator cannot be maintained appropriately. For this reason, it is required to maintain the tightening load between the casing and the stator appropriately even when used in a high temperature environment.

The present invention has been made in view of the above, and an object of the present invention is to provide a rotary electric machine and a manufacturing method of a rotary electric machine that enable appropriate maintenance of the tightening load between a casing and a stator even when used in a high temperature environment.

### Solution to Problem

In order to solve the above-mentioned problem and achieve the object, a rotary electric machine according to the present disclosure is a rotary electric machine including: a rotor; a stator made of an iron-based member and provided on an outer periphery of the rotor; and a casing that is made of an aluminum alloy member, houses the rotor and the stator, and fixes the stator by bringing an inner peripheral surface into contact with an outer peripheral surface of the stator, in which the casing is permanently grown before fixing the stator in the casing.

It is preferable that, in the casing, the ratio of the inner diameter when heated at 200° C. for five hours to the inner diameter at room temperature is 100.35% or more and 100.39% or less.

It is preferable that the casing is made of an ADC12 member.

In order to solve the above-mentioned problem and achieve the object, a manufacturing method of a rotary electric machine according to the present disclosure is a manufacturing method of a rotary electric machine including a rotor, a stator made of an iron-based member and provided on an outer periphery of the rotor, and a casing that is made of an aluminum alloy member and houses the rotor and the stator, the manufacturing method including a heating step of heating the casing to bring the casing into a permanently grown state, and an insertion step of inserting the stator into the permanently grown casing, and bringing an inner peripheral surface of the casing into contact with an outer peripheral surface of the stator to fix the stator to the casing.

### BRIEF DESCRIPTION OF DRAWINGS

FIG. 1 is a cross-sectional view of a rotary electric machine according to the present embodiment.

FIG. 2 is an exploded view of a part of the rotary electric machine according to the present embodiment.

FIG. 3 is a schematic view showing the inner diameter of a casing and the outer diameter of a stator.

FIG. 4 is a diagram illustrating a manufacturing method of a rotary electric machine.

FIG. 5 is a cross-sectional view of a rotary electric machine according to another example of the present embodiment.

FIG. 6 is a schematic view of a test piece according to an example.

FIG. 7 is a graph showing the permanent growth amount of the test piece.

FIG. 8 is a graph showing the permanent growth amount of the test piece.

FIG. 9 is a graph showing the permanent growth amount of the test piece.

FIG. 10 is a graph showing the permanent growth amount of the test piece.

### DESCRIPTION OF EMBODIMENTS

Hereinafter, preferred embodiments of the present invention will be described in detail with reference to the drawings. Note that the present invention is not limited to the embodiments described below.

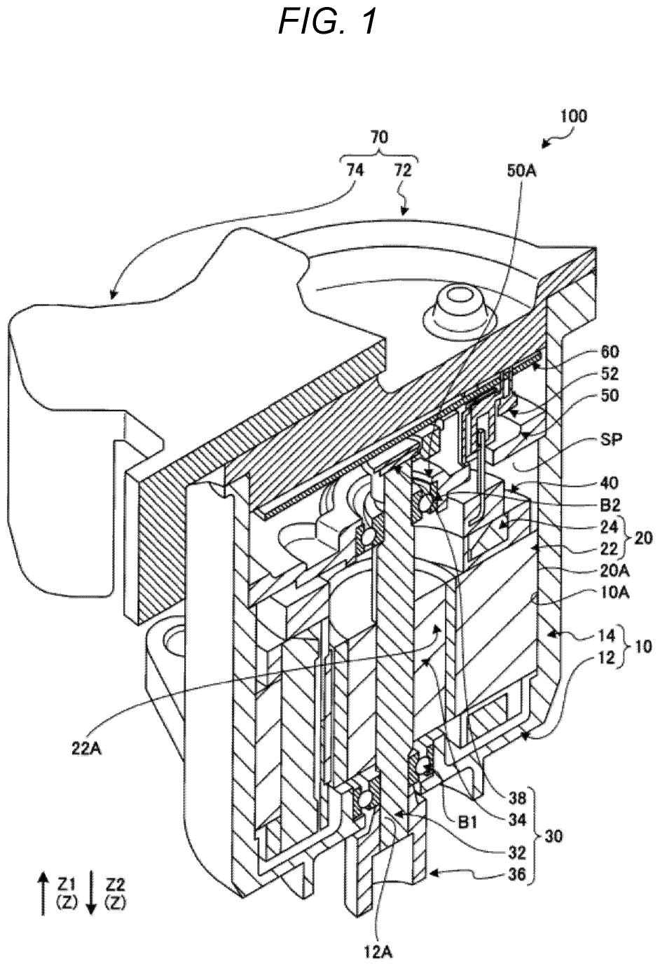

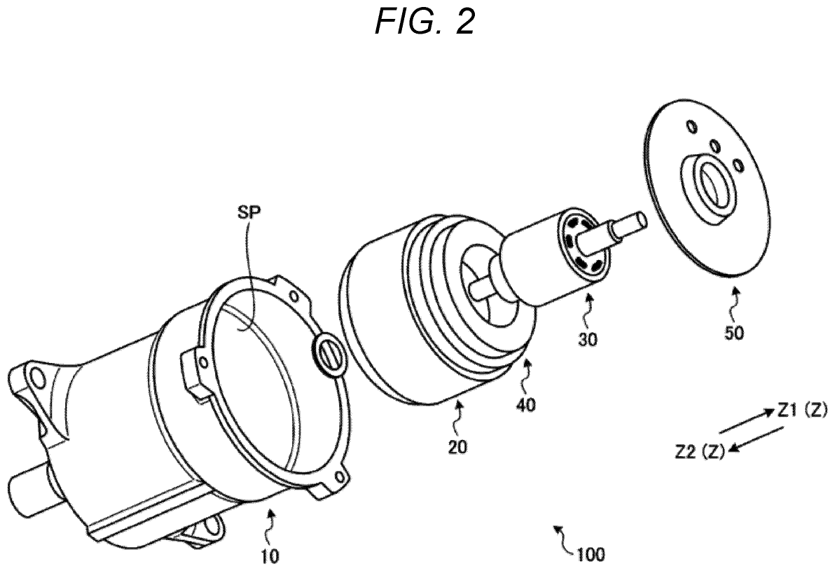

FIG. 1 is a cross-sectional view of a rotary electric machine according to the present embodiment, and FIG. 2 is an exploded view of a part of the rotary electric machine according to the present embodiment. A rotary electric machine 100 according to the present embodiment is a motor, more specifically, a brushless motor. The rotary electric machine 100 is used in an electric steering device of a vehicle, for example, and applies a steering assist force to a steering shaft of the vehicle. Note, however, that the application of the rotary electric machine 100 is not limited to this.

As shown in FIG. 1, the rotary electric machine 100 includes a casing 10, a stator 20, a rotor 30, a bus bar unit 40, a holding member 50, a board 60, a cover member 70, and bearings B1, B2. Note that FIG. 2 is an exploded view of the casing 10, the stator 20, the rotor 30, the bus bar unit 40, and the holding member 50, and the board 60 and the cover member 70 are omitted. Hereinafter, a direction along the axial direction of the rotor 30, more specifically, a drive shaft 32 described later, is referred to as direction Z. Then, one of directions along direction Z is referred to as direction Z1, and the other direction of the directions along direction Z, that is, the direction opposite to direction Z1 is referred to as direction Z2.

As shown in FIG. 1, the casing 10 is a housing that internally houses the stator 20, the rotor 30, the bus bar unit 40, the holding member 50, and the board 60. The casing 10 is a hollow member that is open on the direction Z1 side, and in the present embodiment, is a cylindrical member that is circular when viewed in direction Z. The casing 10 includes a bottom portion 12 and a side portion 14. The bottom portion 12 forms a bottom surface of the casing 10 on the direction Z2 side. An opening 12A through which the drive shaft 32 described later is inserted is formed in the bottom portion 12. Additionally, a bearing B1 which is a bearing is provided on a surface of the bottom portion 12 on the direction Z1 side. The bearing B1 is provided so as to surround the opening 12A when viewed in direction Z, and is fixed to the bottom portion 12. The side portion 14 forms a side surface of the casing 10. The side portion 14 is provided so as to surround the outer edge of the bottom portion 12, and extends in direction Z1 from the outer edge of the bottom portion 12. The casing 10 houses the stator 20, the rotor 30, the bus bar unit 40, the holding member 50, and the board 60 in a space SP surrounded by the bottom portion 12 and the side portion 14. Since an end portion of the casing 10 on the direction Z1 side is open, the space SP communicates with the outside on the direction Z1 side.

The casing 10 is made of an aluminum alloy member. More specifically, the casing 10 is made of a member of ADC12 standardized by JIS. Note, however, that the casing 10 does not necessarily have to be made of ADC12, and may be made of an aluminum alloy that undergoes permanent growth.

The stator 20 is a stator of the rotary electric machine 100. The stator 20 is provided in the casing 10, that is, in the space SP of the casing 10. The stator 20 includes a stator core 22 and a stator coil 24. The stator core 22 is the core of the stator 20, and a through hole 22A penetrating in direction Z is formed at the center position when viewed in direction Z. The stator core 22 is made of a magnetic material, and more specifically, is made of an iron-based member. An iron-based member is a member containing iron as a main component. More specifically, the stator core 22 according to the present embodiment is made of an electromagnetic steel plate. The stator core 22 is made by laminating electromagnetic steel plate members in direction Z. Note, however, that the stator core 22 does not necessarily have to be made of electromagnetic steel plates, and does not necessarily have to be made of members laminated in direction Z. The stator core 22 may be an iron-based member that does not grow permanently.

The stator coil 24 is a coil of the stator 20. The stator coil 24 includes U-phase, V-phase, and W-phase electromagnetic coils. The stator coil 24 is wound around the stator core 22.

The stator 20 is fixed to the casing 10 by bringing an outer peripheral surface 20A into contact with the inner peripheral surface 10A of the casing 10. That is, the stator 20 is fitted to the casing 10 by being interference-fitted (press-fitted) into the casing 10. It can be said that the outer peripheral surface 20A of the stator 20 and the inner peripheral surface 10A of the casing 10 are fitted portions. Note that incidentally, the outer peripheral surface 20A is an outer peripheral surface of the stator core 22, and the inner peripheral surface 10A is an inner peripheral surface of the side portion 14 of the casing 10.

The rotor 30 is a rotor of the rotary electric machine 100. The rotor 30 is provided in the space SP of the casing 10. The rotor 30 includes the drive shaft 32 and a rotor core 34. The rotor core 34 is the core of the rotor 30. The rotor core 34 includes a plurality of magnetic poles arranged in the circumferential direction. The rotor core 34 has a through hole penetrating in direction Z formed at the center position when viewed in direction Z. The drive shaft 32 is a shaft, which is inserted into the through hole of the rotor core 34 and fixed to the rotor core 34. That is, the drive shaft 32 is interference-fitted (press-fitted) to the rotor core 34. In the rotor 30, an outer peripheral surface of the rotor core 34 is provided in the through hole 22A of the stator core 22. The rotor 30 is provided in the through hole 22A so that the axial direction of the drive shaft 32 is along direction Z. Additionally, the rotor 30 is provided in the through hole 22A so as to be rotatable with respect to the stator 20. Since the rotor 30 is inserted into the through hole 22A in this way, it can be said that the stator 20 is provided on the outer periphery of the rotor 30. The rotor 30 rotates about the central axis of the drive shaft 32 extending along direction Z as a rotation axis, due to electromagnetic action with the stator 20.

Additionally, a gear portion 36 is attached to an end portion of the drive shaft 32 on the direction Z2 side. The gear portion 36 meshes with a gear (not shown) on the other side that communicates with the steering shaft, and transmits the rotation of the drive shaft 32 to the steering shaft. Additionally, a detector 38 is attached to an end portion of the drive shaft 32 on the direction Z1 side. The detector 38 is a member for detecting the rotation speed of the rotor 30, and is a magnet or a magnetic sensor, for example.

The bus bar unit 40 is provided on the direction Z1 side of the stator coil 24 in the space SP of the casing 10. The bus bar unit 40 is a plate-shaped (disk-shaped in this example) member including a plurality of bus bars and a bus bar holder. The bus bar is a conductive member and is connected to each of the U phase, V phase, and W phase of the stator coil 24. The bus bar holder is an insulating member and covers the bus bar.

The holding member 50 is provided on the direction Z1 side of the bus bar unit 40 in the space SP of the casing 10. The holding member 50 is a plate-shaped (disc-shaped in this example) member that holds the bearing B2. For example, the holding member 50 is fixed to the casing 10 by bringing the outer peripheral surface thereof into contact with the inner peripheral surface 10A of the casing 10. That is, the holding member 50 is interference-fitted (press-fitted) to the casing 10. Note, however, that the holding member 50 does not necessarily have to be interference-fitted to the casing 10. The holding member 50 has a through hole 50A formed at the center position when viewed in direction Z. A bearing B2 which is a bearing is provided in the through hole 50A. Since the bearing B2 is fixed to the holding member 50, it can be said that the bearing B2 is fixed to the casing 10 through the holding member 50. Note that the holding member 50 is made of the same material (member) as the casing 10, but is not limited to this, and may be made of a material different from that of the casing 10.

Note that the drive shaft 32 of the rotor 30 is rotatably supported by the bearings B1, B2. That is, a portion of the drive shaft 32 on the direction Z2 side is rotatably inserted into the bearing B1, and a portion on the direction Z1 side of the portion inserted into the bearing B1 is rotatably inserted into the bearing B2.

The board 60 is provided on the direction Z1 side of the holding member 50 in the space SP of the casing 10. The board 60 is a circuit board on which a circuit of an ECU (electronic control unit) of the rotary electric machine 100 is provided. The board 60 is electrically connected to the bus bar of the bus bar unit 40 through a connecting portion 52 provided between the board 60 and the bus bar unit 40.

The cover member 70 is provided on the end portion of the casing 10 on the direction Z1 side. The cover member 70 includes a cover 72 and a terminal portion 74. The cover 72 is a cover that closes an opening on the direction Z1 side of the space SP of the casing 10. The cover 72 is attached to the casing 10 so as to cover the opening at the end portion of the casing 10 on the direction Z1 side. The terminal portion 74 is attached to the cover 72. The terminal portion 74 includes a wiring (not shown) electrically connected to the circuit of the board 60 and a terminal connected to the wiring.

The rotary electric machine 100 having the above configuration is used in a high temperature environment of 105° C. or higher, for example. Since the casing 10 is made of an aluminum alloy, it is heated by being placed in a high temperature environment and grows permanently. Permanent growth refers to dimensional changes due to precipitation of overdissolved elements in a high temperature environment. Since permanent growth is an irreversible expansion, even if the permanently grown member is cooled after heating, the expanded portion corresponding to the permanent growth does not return to the original state. For this reason, in the rotary electric machine 100 using the casing 10 made of an aluminum alloy that grows permanently, the inner diameter of the casing 10 increases when used in a high temperature environment. On the other hand, the stator 20 made of an iron-based member does not grow permanently. Hence, when the rotary electric machine 100 is used in a high temperature environment, there is a possibility that the tightening margin between the casing 10 and the stator 20 is reduced, and the tightening load of the fitted portion is not maintained appropriately. The tightening load refers to a force acting due to the contact between the inner peripheral surface 10A of the casing 10 and the outer peripheral surface 20A of the stator 20, and refers to a force for fixing the stator 20 to the casing 10. If the tightening load cannot be maintained appropriately, the stator 20 may come off the casing 10, causing damage to the rotary electric machine 100 or drive failure of the rotary electric machine 100. On the other hand, in the rotary electric machine 100 according to the present embodiment, before the use of the rotary electric machine 100, more specifically, before the stator 20 is inserted into the casing 10 and the stator 20 is fixed in the casing 10, the casing 10 is heated to grow the casing 10 permanently in advance. By permanently growing the casing 10 in advance, even when the rotary electric machine 100 is used in a high temperature environment, further permanent growth of the casing 10 can be curbed, and reduction of the tightening margin can be curbed. Hereinafter, the point of permanently growing the casing 10 in advance will be described in detail.

In the present embodiment, the casing 10 is brought into a permanently grown state by heating the casing 10 by a heat treatment before the use of the rotary electric machine 100. For this reason, the casing 10 assembled to the rotary electric machine 100 is permanently grown in the state before the use of the rotary electric machine 100. The permanently grown state refers to a state in which the casing 10 has already grown permanently. What is more, the permanently grown state more preferably refers to a state in which the casing 10 has permanently grown to the maximum and does not grow any more (i.e., state in which permanent growth is saturated). Additionally, here, before the use of the rotary electric machine 100 refers to a state before the rotary electric machine 100 is mounted on an object such as a vehicle on which the rotary electric machine 100 is mounted (state in which rotary electric machine 100 is not mounted on object). What is more, assuming that an environment in which the casing 10 before permanent growth becomes permanently grown is a permanent growth environment, the use of the rotary electric machine 100 refers to placing the rotary electric machine 100 to which the casing 10 is assembled in a permanent growth environment. That is, before the use of the rotary electric machine 100 refers to a state in which the rotary electric machine 100 to which the casing 10 is assembled has not been placed in a permanent growth environment so far. The permanent growth environment refers to placing a member in a predetermined temperature for a predetermined time, where the predetermined temperature is 105° C. or higher, for example, and the predetermined time is five hours or longer, for example.

In the present embodiment, the casing 10 is brought into a permanently grown state by heating the casing 10 by a heat treatment. The heat treatment here can be rephrased as placing the casing 10 in a permanent growth environment. That is, the heat treatment condition here may be that the casing 10 is heated to the above-mentioned predetermined temperature for a predetermined time. What is more, in the present embodiment, the casing 10 is subjected to a T5 treatment as a heat treatment. The T5 treatment here is, for example, a treatment in which a member is heated at 200° C. or higher and 240° C. for 2 hours or more and 6 hours or less to quench the member. Note, however, that the heat treatment condition here may be any condition as long as the casing 10 is brought into a permanently grown state.

Note that in the present embodiment, it is preferable that the casing 10 is heated to bring the casing 10 into a permanently grown state before assembling the casing 10 to the rotary electric machine 100, in other words, before inserting the stator 20 into the casing 10.

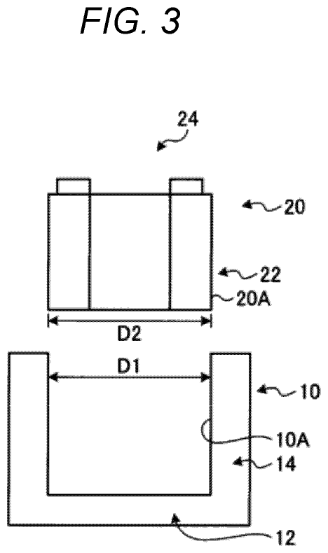

FIG. 3 is a schematic view showing the inner diameter of the casing and the outer diameter of the stator. As shown in FIG. 3, hereinafter, the inner diameter of the casing 10 is referred to as an inner diameter D1, and the outer diameter of the stator 20 is referred to as an outer diameter D2. It can be said that the inner diameter D1 is the inner diameter of the side portion 14 of the casing 10 and the outer diameter D2 is the outer diameter of the stator core 22. Here, the difference between the outer diameter D2 and the inner diameter D1 when the stator 20 is removed from the casing 10 is defined as a dimensional difference D. That is, it can be said that the dimensional difference D is a value obtained by subtracting the inner diameter D1 of the casing 10 from the outer diameter D2 of the stator 20 when the stator 20 is removed from the casing 10 after the stator 20 is inserted into and fixed to the casing 10. It can be said that the dimensional difference D corresponds to the tightening margin between the casing 10 and the stator 20. In this case, in the rotary electric machine 100, it is preferable that the ratio of the dimensional difference D to the inner diameter D1 when the stator 20 is removed from the casing 10 is 0.06% or more and 0.33% or less. When this ratio is 0.06% or more, the tightening load is maintained appropriately, and when the ratio is 0.33% or less, damage to the casing 10 and the stator 20 due to excessively high press-fit force can be curbed. Moreover, in the rotary electric machine 100, since the casing 10 is permanently grown, the inner diameter D1 of the casing 10 is prevented from becoming too large with respect to the outer diameter D2 of the stator 20 even when used in a high temperature environment. Hence, it is possible to curb a decrease in the tightening load.

Note that since the casing 10 is permanently grown, the dimensional difference D before the use of the rotary electric machine 100 and the dimensional difference D after the use of the rotary electric machine 100 are the same values. That is, it can be said that the above-mentioned dimensional difference D is the difference between the outer diameter D2 and the inner diameter D1 before the use of the rotary electric machine 100, or the difference between the outer diameter D2 and the inner diameter D1 after the use of the rotary electric machine 100. On the other hand, when the stator 20 is interference-fitted to the casing 10, at least one of the casing 10 and the stator 20 is plastically deformed. It can be said that the dimensional difference D is the difference between the outer diameter D2 and the inner diameter D1 after the stator 20 is interference-fitted to the casing 10, that is, after the plastic deformation. For this reason, the difference between the outer diameter D2 and the inner diameter D1, that is, the press-fitting margin before the holding stator 20 is press-fitted into the casing 10 is a value obtained by adding the plastic deformation amount to the dimensional difference D after the interference-fitting.

Note that although the casing 10 is permanently grown, it expands reversibly by heating. The reversible thermal expansion here is a thermal expansion that depends on the coefficient of linear expansion. In the casing 10, it is preferable that the ratio of the inner diameter D1 when heated at 200° C. for five hours to the inner diameter D1 at room temperature is 100.35% or more and 100.39% or less, for example. Note that the room temperature here is 25° C., for example. That is, since the casing 10 is permanently grown, the amount of expansion when placed in a high temperature environment does not depend on permanent growth, but depends on reversible thermal expansion.

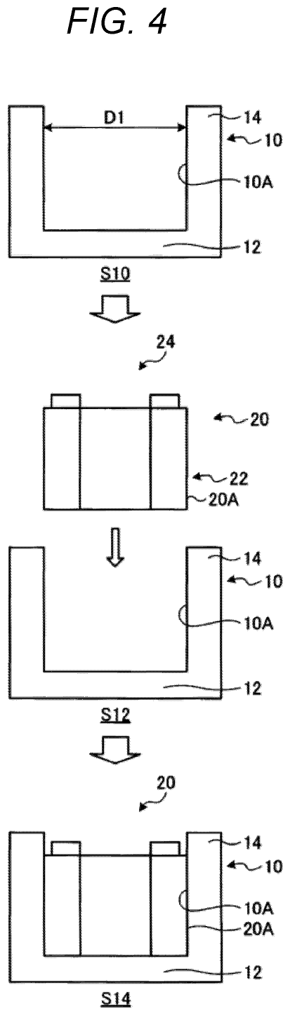

Next, a manufacturing method of the rotary electric machine 100 will be described. FIG. 4 is a diagram illustrating a manufacturing method of a rotary electric machine. As shown in FIG. 4, when manufacturing the rotary electric machine 100, the casing 10 before assembly is heated to bring the casing 10 into a permanently grown state (step S10; heating step). In the present embodiment, after the casing 10 is manufactured by casting, the casing 10 is heated to bring the casing 10 into a permanently grown state. Then, by machining the inner peripheral surface 10A of the permanently grown casing 10, the inner diameter of the permanently grown casing 10 is set to the inner diameter D1 before the stator 20 is inserted into the casing 10. Note, however, that machining is not an essential process. Additionally, in the manufacturing method of the rotary electric machine 100, members (stator 20, rotor 30, and the like) of the rotary electric machine 100 other than the casing 10 are also prepared.

Then, the stator 20 is inserted into the permanently grown casing 10 (step S12), the inner peripheral surface 10A of the casing 10 and the outer peripheral surface 20A of the stator 20 are brought into contact with each other, and the stator 20 is fixed to the casing 10 (step S14). Steps S12 and S14 correspond to the insertion step. In step S12, the stator 20 is inserted into the space SP through the opening at the end portion of the casing 10 on the direction Z1 side. In the present embodiment, the stator 20 is inserted into the casing 10 by shrink fitting. That is, the stator 20 is inserted in a state where the permanently grown casing 10 is heated and the inner diameter of the casing 10 is expanded. Then, by cooling the casing 10 with the stator 20 placed in the casing 10, the inner diameter of the casing 10 is restored, and the inner peripheral surface 10A of the casing 10 and the outer peripheral surface 20A of the stator 20 come into contact with each other. Thus, the stator 20 is brought into an interference-fitted state fixed to the casing 10. Note, however, that the method of inserting the stator 20 into the casing 10 is not limited to shrink fitting. For example, the stator 20 may be press-fitted into the unheated casing 10.

After fixing the stator 20 to the casing 10, the rotor 30, the bus bar unit 40, the holding member 50, the board 60, and the cover member 70 are assembled to the casing 10 to complete the production of the rotary electric machine 100 (not shown). Note that the rotor 30 may be attached to the stator 20 after the stator 20 is inserted into the casing 10.

As described above, the rotary electric machine 100 according to the present embodiment includes the rotor 30, the stator 20, and the casing 10. The stator 20 is made of an iron-based member and is provided on the outer periphery of the rotor 30. The casing 10 is made of an aluminum alloy member. The casing 10 houses the rotor 30 and the stator 20, and the inner peripheral surface 10A comes into contact with the outer peripheral surface 20A of the stator 20 to fix the stator 20. The casing 10 is permanently grown before the stator 20 is fixed in the casing 10. Here, when the rotary electric machine using the casing that grows permanently is used in a high temperature environment, there is a possibility that the casing grows permanently, the tightening margin between the casing and the stator is reduced, and the tightening load cannot be maintained appropriately. On the other hand, in the rotary electric machine 100 according to the present embodiment, the casing 10 is permanently grown before the use of the rotary electric machine 100. For this reason, the rotary electric machine 100 according to the present embodiment can curb reduction in the tightening margin between the casing 10 and the stator 20 by curbing further permanent growth of the casing 10 even when used in a high temperature environment. Hence, the rotary electric machine 100 according to the present embodiment can maintain the tightening load between the casing 10 and the stator 20 appropriately even when used at a high temperature. Additionally, when the cover 72 inserted into the casing 10 maintains airtightness with the casing 10 by an O-ring, packing, or the like, the airtightness can be maintained by permanently growing the casing 10 in advance. Additionally, by permanently growing the casing 10 in advance, it is possible to curb changes in cogging and ripple of the rotary electric machine 100.

Additionally, in the casing 10, it is preferable that the ratio of the inner diameter when heated at 200° C. for five hours to the inner diameter at room temperature is 100.35% or more and 100.39% or less. When the amount of thermal expansion when the casing 10 is heated is within this range, further permanent growth of the casing 10 is curbed, and the tightening load between the casing 10 and the stator 20 can be maintained appropriately.

Additionally, the casing 10 is preferably made of an ADC12 member. The rotary electric machine 100 according to the present embodiment can be mounted appropriately on a vehicle by using the casing 10 made of ADC12. Additionally, by making the casing 10 permanently grown, it is possible to maintain the tightening load between the casing 10 and the stator 20 appropriately even when the casing 10 made of ADC12 is used.

Additionally, the stator 20 preferably contains an electromagnetic steel plate. In the rotary electric machine 100 according to the present embodiment, even when the stator 20 of an electromagnetic steel plate is used, the tightening load between the casing 10 and the stator 20 can be maintained appropriately by making the casing 10 permanently grown.

Additionally, the manufacturing method of the rotary electric machine 100 according to the present embodiment includes a heating step and an insertion step. In the heating step, the casing 10 is heated to a permanently grown state. In the insertion step, the stator 20 is inserted into the permanently grown casing 10, the inner peripheral surface 10A of the casing 10 is brought into contact with the outer peripheral surface 20A of the stator 20, and the stator 20 is fixed to the casing 10. According to the manufacturing method of the rotary electric machine 100 according to the present embodiment, since the stator 20 is inserted into the permanently grown casing 10, the tightening load between the casing 10 and the stator 20 can be maintained appropriately even when the rotary electric machine 100 is used at a high temperature.

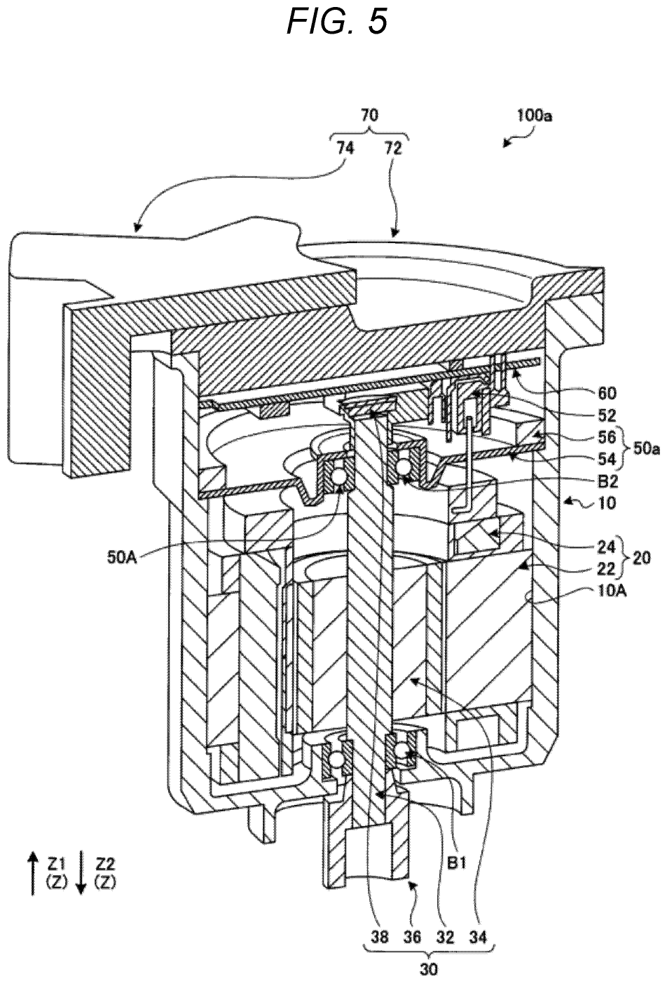

FIG. 5 is a cross-sectional view of a rotary electric machine according to another example of the present embodiment. The holding member 50 of the rotary electric machine 100 is made of one member as shown in FIG. 1, but may be made of a plurality of members as shown in the other example of FIG. 5, for example. As shown in FIG. 5, a holding member 50a of a rotary electric machine 100a according to the other example includes a bearing holder 54 and a ring 56. The bearing holder 54 is provided on the direction Z1 side of a bus bar unit 40 in a space SP of a casing 10. The bearing holder 54 is a plate-shaped member, and has a through hole 50A into which a bearing B2 is inserted. In this example, the bearing holder 54 is not interference-fitted to the casing 10, and at least a part of an outer peripheral surface of the bearing holder 54 is separated from an inner peripheral surface 10A of the casing 10. Note that the material of the bearing holder 54 is arbitrary, but may be the same material as that of the casing 10, for example.

The ring 56 is an annular member. The material of the ring 56 is arbitrary, but may be the same material as the casing 10, for example. The ring 56 is provided on the direction Z1 side of the bearing holder 54 in the space SP of the casing 10. In the ring 56, a surface on the direction Z2 side is in contact with a surface of the bearing holder 54 on the direction Z1 side. The ring 56 is fixed to the casing 10 by bringing the outer peripheral surface thereof into contact with the inner peripheral surface 10A of the casing 10. That is, the ring 56 is press-fitted into the casing 10. The ring 56 comes into contact with the bearing holder 54 to fix the bearing holder 54 to the casing 10. That is, the bearing holder 54 is fixed to the casing 10 through the ring 56. As described above, even when the holding member is made of a plurality of members, by making the casing 10 permanently grown, it is possible to maintain the tightening load between the casing 10 and the stator 20 appropriately.

### Experimental Example

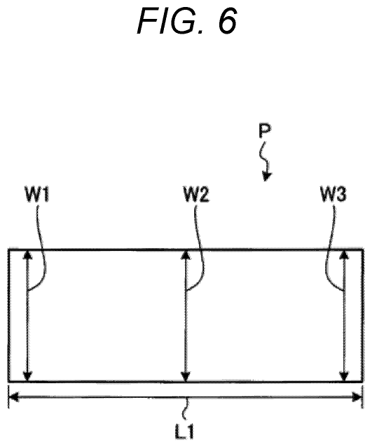

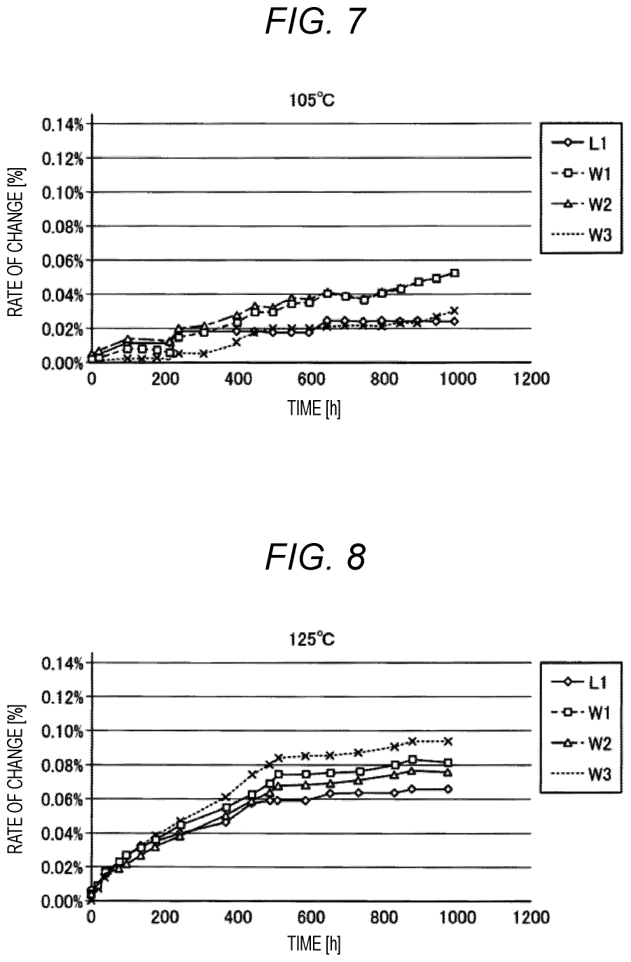

Next, an experimental example will be described. In the experimental example, permanent growth of a test piece P made of the same material (member) as the casing 10 was measured. FIG. 6 is a schematic diagram of a test piece according to the experimental example, and FIGS. 7 to 10 are graphs showing the permanent growth amount of the test piece. As shown in FIG. 6, in the experimental example, a rectangular plate-shaped test piece P was used to permanently grow the test piece P. In the experimental example, the test piece P which was not permanently grown, that is, which was not placed in the permanent growth environment, was heated to each temperature, and the dimensions of the test piece P were measured. Specifically, a length L1 of the long side of the test piece P, a length (width) W1 of the short side at one end in the long side direction of the test piece P, a length (width) W2 of the short side at the center position in the long side direction of the test piece P, and a length (width) W3 of the short side at the other end in the long side direction of the test piece P were measured. What is more, in the experimental example, the lengths L1, W1, W2, and W3 of the test piece P in the non-permanently grown state, that is, the test piece P before heating, at 25° C. were measured. Then, the test piece P was heated at a set heating temperature for a set time, then returned to 25° C., and the lengths L1, W1, W2, and W3 were measured. Then, the dimensional difference of the lengths L1, W1, W2, and W3 before and after heating was calculated, and the rate of dimensional change (%) was calculated. The rate of change here refers to the ratio of the difference between the length after heating and the length before heating to the length before heating (lengths L1, W1, W2, W3). That is, it can be said that the rate of change is a value indicating the permanent growth amount.

FIG. 7 shows the rate of change when the test piece P was heated at 105° C. In FIG. 7, the horizontal axis represents the elapsed heating time, and the vertical axis represents the measured values of the lengths L1, W1, W2, and W3 for each heating time. In the experimental example according to FIG. 7, the test piece P before permanent growth was heated in an environment of 105° C. (heating temperature), heated for a predetermined heating time to measure the lengths L1, W1, W2, and W3, and then heated further to measure the lengths L1, W1, W2, and W3 at each elapsed heating time. Then, for each test piece P, the lengths L1, W1, W2, and W3 were measured before and after heating, and the rate of change for each heating time was calculated. As shown in FIG. 7, when the heating temperature is 105° C., the test piece P grows permanently, and it can be seen that the longer the heating time, the larger the permanent growth amount. Note that in the experimental examples of FIG. 8 and following drawings, the rate of change for each heating time was calculated under similar conditions as in the experimental example of FIG. 7 except for the heating temperature.

FIG. 8 shows the rate of change when the test piece P was heated at 125° C. In the experimental example of FIG. 8, the test piece P before permanent growth was heated in an environment of 125° C. (heating temperature), and the rate of change for each heating time was calculated. As shown in FIG. 8, it can be seen that the test piece P grows permanently when the heating temperature is 125° C. Additionally, it can be seen that the longer the heating time, the larger the permanent growth amount, and the permanent growth amount becomes almost constant in about 500 hours.

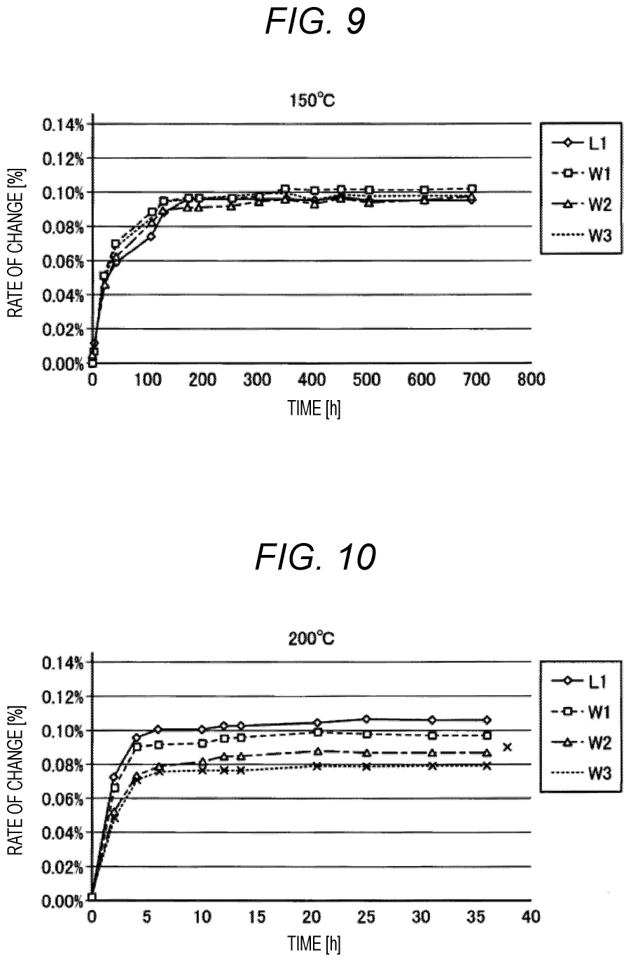

FIG. 9 shows the rate of change when the test piece P was heated at 150° C. In the experimental example of FIG. 9, the test piece P before permanent growth was heated in an environment of 150° C. (heating temperature), and the rate of change for each heating time was calculated. As shown in FIG. 9, it can be seen that the test piece P grows permanently when the heating temperature is 150° C. Additionally, it can be seen that the longer the heating time, the larger the permanent growth amount, and the permanent growth amount becomes almost constant in about 150 hours.

FIG. 10 shows the rate of change when the test piece P was heated at 200° C. In the experimental example of FIG. 10, the test piece P before permanent growth was heated in an environment of 200° C. (heating temperature), and the rate of change for each heating time was calculated. As shown in FIG. 10, it can be seen that the test piece P grows permanently when the heating temperature is 200° C. Additionally, it can also be seen that the longer the heating time, the larger the permanent growth amount, and the permanent growth amount becomes almost constant in about five hours.

As described above, it can be seen that the test piece P using the same material as the casing 10 grows permanently when heated at a heating temperature of 105° C. or higher and 250° C. or lower. Additionally, it can be seen that the maximum amount of change, that is, the maximum amount of permanent growth is about 0.12%.

While the embodiments of the present invention have been described above, embodiments are not limited by the contents of these embodiments and the like. Additionally, the components described above include those that are easily assumable by those skilled in the art, those that are substantially the same, and those that are in a so-called equivalent range. Moreover, the components described above can be combined appropriately. Furthermore, various omissions, replacements or changes of the components can be made without departing from the gist of the above-described embodiments.

According to the present disclosure, the tightening load between a casing and a stator can be maintained appropriately even when used in a high temperature environment.

### REFERENCE SIGNS LIST

10 casing
10A inner peripheral surface
12 bottom portion
14 side portion
20 stator
20A outer peripheral surface
22 stator core
24 stator coil
30 rotor
32 drive shaft
34 rotor core
40 bus bar unit
50 holding member
60 board
70 cover member
100 rotary electric machine

1. A rotary electric machine comprising:
a rotor;
a stator made of an iron-based member and provided on an outer periphery of the rotor; and
a casing that is made of an aluminum alloy member, houses the rotor and the stator, and fixes the stator by bringing an inner peripheral surface into contact with an outer peripheral surface of the stator, wherein
the casing is permanently grown before fixing the stator in the casing.

2. The rotary electric machine according to claim 1, wherein in the casing, a ratio of an inner diameter when heated at 200° C. for five hours to an inner diameter at room temperature is 100.35% or more and 100.39% or less.

3. The rotary electric machine according to claim 1, wherein the casing is made of an ADC12 member.

4. A manufacturing method of a rotary electric machine including a rotor, a stator made of an iron-based member and provided on an outer periphery of the rotor, and a casing that is made of an aluminum alloy member and houses the rotor and the stator, the manufacturing method comprising:
a heating step of heating the casing to bring the casing into a permanently grown state; and
an insertion step of inserting the stator into the permanently grown casing, and bringing an inner peripheral surface of the casing into contact with an outer peripheral surface of the stator to fix the stator to the casing.
